(19) United States
(12) Patent Application Publication
(10) Pub. No.: US 2007/0110403 A1
(43) Pub. Date: May 17, 2007

(54) Video capture system input control

(75) Inventor: Peter Diamond, Stockport (GB)

Correspondence Address: NOTARO AND MICHALOS, 100 DUTCH HILL ROAD, SUITE 110, ORANGEBURG, NY, 10962-2100, US

(73) Assignee: BAXALL LIMITED, BREDBURY, STOCKPORT (GB)

(21) Appl. No.: 10/555,143

(22) PCT Filed: Apr. 26, 2004
(86) PCT No.: PCT/GB04/01772

§ 371 Date: Jan. 29, 2007

(30) Foreign Application Priority Data
Apr. 30, 2003 (GB) 0309939.7

(51) Int. Cl. H04N 7/26

(52) U.S. Cl. 386/109

(57) ABSTRACT

A video capture system includes an input mean for receiving a plurality of analogue video signals, each analogue video signal including a plurality of active periods, there being dead time periods between successive inputs of different video signals; a switching mechanism for selecting any one of the analogue video signals for capture; a switching control for receiving information relating to the active periods of each analogue video signal and/or the dead time periods between some or all of the video signals, and determining the operation of the switching mechanism on the basis of this information to select the order in which the analogue video signals are captured.

The present invention relates to a video capture system and in particular to such a system which has multiple analogue video inputs. One example of such a system is a security system with a plurality of cameras.

A security system which accepts a plurality of analogue video inputs is usually constrained by cost such that all of the video inputs cannot be viewed or recorded at the same time. In the circumstances, the system uses a time division multiplexed front end to capture small samples from each input in turn, for either viewing or recording. This means that only one set of input circuitry is required to capture the signals from all cameras, but that the input rate from each camera is less than real time.

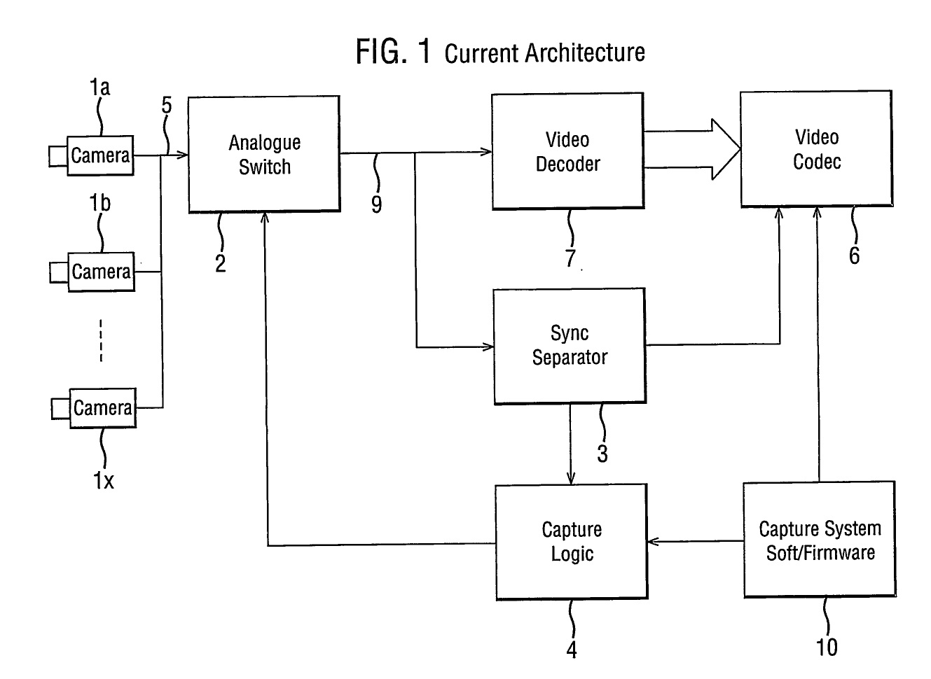

A typical multiplexed video security system includes a plurality of analogue video cameras, from each of which video signals are received by a central system. The central system typically includes a recording device for recording the video images from one of the cameras at a time, and also a monitoring device for viewing the video images from one of the cameras at a time. An example of such a system is shown in FIG. 1.

In FIG. 1, a plurality of analogue video cameras 1a, 1b . . . 1x, feed their respective analogue video signals to an input 5 of an analogue switch 2. The operation of the analogue switch 2 determines which of the cameras is connected to the capture system video input 9. Only one of the cameras at a time is connected to the capture system video input 9 and the capture system may include a video display and/or recorder (not shown).

The analogue switch 2 is controlled by the system software or firmware 10 and capture logic 4. The capture logic 4 receives synchronisation signals filtered from the video data by sync separator 3 so that it can determine when the active region of the current video input is available to be captured. The sync separator is used to convert the synchronisation signals incorporated in the analogue video signals into digital form so that they can be used by the capture logic 4. Once the desired image has been captured, the capture logic indicates that capture is complete and therefore the capture system software/firmware can proceed to capture the next image (e.g. from a different camera) as required.

At the capture system video input 9, the video signals are input to a video decoder 7 which is essentially an analogue to digital converter. The digitised video signals are then passed to a video Codec 6 (a compression and decompression device). The synchronisation signals from the video decoder 7 are used to drive the control mechanism of the video Codec 6. A typical video camera image has a digitised resolution of 864 pixels by 312.5 lines and each of these images is passed to the video Codec 6 in turn, for compression. The Codec 6 uses the synchronisation signals to identify which lines and pixels from the incoming image data to compress. The applicant has realised that the result of this dependence on the synchronisation signals is that no matter what portion or subset of the image merits compression, the time taken for the compression of each image is the same every time, since the compression is constrained by the time base of the incoming signal (i.e. 20 milliseconds for every field of a standard PAL signal).

In more detail, for each individual image capture, the following process is carried out:
1. An appropriate sync signal appears at the output of the sync separator 3. This will usually be a vertical synchronisation signal.
2. The capture logic 4 starts the image capture process.
3. By monitoring the sync separator 3 output, the capture logic 4 counts the image lines until the first image to be collected is complete.
4. The next camera is selected from which an image is to be collected.
5. Repeat steps 1-4 as desired.

However, since the video signals from the cameras are asyncronous with respect to each other, there is no predetermined time period between successive captured images. This causes real time software coding and debugging issues for programmers. Furthermore, the sync signals of the cameras will beat against each other over time and the software/firmware will be interrupted at irregular and indeterminable intervals, causing further problems.

In one example, the capture system would change between the inputs of different cameras in a predetermined order e.g. it would cycle through each camera in turn. Alternatively, the system may be set up to alternate between a pair of cameras, or a larger set of cameras. Furthermore, either of these examples could be set up such that the cycle was interrupted to change to the input of a different camera, e.g. on the request of a user or on the receipt of an alarm condition. In such a case, one or more additional cameras may be added to the sequence, either on an exclusive basis (e.g. recorded on its/their own) or on an interleaved basis e.g. recorded in addition to the existing cameras at the same or a different rate.

Also since there is no predetermined time period (dead time”) between successive captured images, the average capture rate for the system is not accurately specifiable and in any event it changes with the number of cameras connected to the system. Furthermore, the instantaneous capture rate varies with time. In addition, the applicant has realised that the use of the Codec in the prior art architecture is inefficient.

The present invention aims to provide a system which addresses some or all of these problems.

Accordingly, in a first aspect, the present invention provides a video capture system including:
input means for receiving a plurality of analogue video signals, each analogue video signal including a plurality of active periods, there being dead time periods between successive inputs of different video signals;
switching means for selecting any one of the analogue video signals for capture;
switching control means for receiving information relating to the active periods of each analogue video signal and/or the dead time periods between some or all of the video signals, and determining the operation of the switching means on the basis of this information to select the order in which the analogue video signals are captured.

In this way, the switching control means can be used to avoid or reduce the uncertainty in capture rate and/or the poor capture rate associated with the prior art systems.

In one embodiment of the present invention, the switching control means selects the order in which the analogue video signals are processed so as to substantially maintain a desired average capture rate. Additionally or alternatively, the switching control means may select the order in which the analogue video signals are processed in order to achieve an increased capture rate (i.e. a reduction in dead time between capture of different ones of the analogue video signals) or even to maximise the capture rate. Additionally or alternatively, the switching control means may operate so as to maintain the capture rate above a predetermined minimum rate.

In one embodiment the switching control means measures the time from the end of each collection until the start of the next e.g. using a counter. This value may be used to calculate the accumulated dead time and/or individual dead times between collections.

Preferably the control means controls the operation of the switching means. The switching control means may monitor the signals output from the switching means and preferably detects the “active” portion of each frame of each analogue video signal i.e. that portion of the frame containing image data. The switching control means may control the switching means to select between different ones of the plurality of analogue video signals in accordance with the order determined by the information received. For example, the switching control means may control the switching means to switch at the end of an active region of a first signal to then select a second analogue video signal and so on. Additionally or alternatively, a plurality of active regions of a first signal may be captured before operating the switching means to select a second analogue video signal and so on.

Preferably the switching control means can determine any order for capturing the analogue video signals and may amend that order as desired e.g. at predetermined time intervals. Additionally or alternatively, the capture order may be selected from a predetermined list of available capture orders and such a selection may be done on the basis of which of the available orders most closely provides the desired objective as mentioned before e.g. obtaining a desired average collection rate, a best possible collection rate and/or maintaining a minimum collection rate. Similarly, the selection may be repeated (and changed if necessary) as desired e.g. at predetermined time intervals.

The capture rate for a typical system is preferably, but not restricted to around 50 fields per second (FPS), shared between all inputs, and more preferably around 30-50 FPS.

In a second aspect, the present invention provides a method of operating a video capture system, the method including the steps of:
1. receiving analogue video signals from a plurality of sources, each analogue video signal including a plurality of active periods and respective dead time periods between the active periods;
2. selecting a signal from one of the sources for capture;
3. receiving information relating to the active period and/or dead time periods of the analogue video signals;
4. repeating step 2 on the basis of the information received in step 3.

As mentioned above in relation to the operation of the Apparatus, the signal selection in step 2 may be done on the basis of maintaining one or more of various desired operational parameters, such as a predetermined average capture rate, a higher or maximum capture rate and/or a minimum capture rate. Other preferred steps of the method will be apparent from the description of the operation of the apparatus given above.

In a further aspect, the present invention provides a video security system including:
a video capture system as described above; and
a plurality of analogue video cameras whose signals are fed to the input means of the video capture system.

In a further aspect, the present invention provides a video capture system including:
input means for receiving a plurality of analogue video signals;
switching means for selecting any one of the analogue video signals;
memory means for storing signals output from the switching means; and
system control means for extracting signals from the memory means at a predetermined rate, and preferably transferring the signals to video CODEC means.

This aspect may be included with any or all of the above aspects.

The inclusion of the memory means (which may be termed a “throttle buffer”) in the system effectively enables the asynchronous input signals to be synchronised, thereby delivering a deterministic system which reduces software complexity and debugging problems.

Preferably there is only one memory means i.e. the memory means is usable to store signals from all of the input means.

Preferably the system control means is usable for extracting signals from the memory means in a predetermined order, with predetermined dimensions and/or with a predetermined rate. The predetermined order may be different from the order in which the signals are input to the memory and the memory means.

Preferably the video capture system includes means for digitising the signals output from the switching means prior to storage in the memory means.

Preferably switching control means is operated independently of the system control means so that, for example, the switching control means can control the capture of the analogue video signals and, in some examples, their subsequent storage in the memory means in an asynchronous manner at whatever rate is appropriate. Independently of the storage of the signals in the memory means, the system control means may then extract signals from the memory means at the predetermined rate e.g. a chosen “clock” rate to suit any video processing system to which the signals may then be sent. Preferably the predetermined rate of extracting signals from the memory means is approximately the same as the average input rate of the storing of signals in the memory means, so that the memory means will not overflow or empty.

Preferably the switching control means and/or the system control means is/are operable so that the memory means may be written to and read from simultaneously.

Preferably the system control means controls the memory means and/or the digitising means such that only a portion of each signal output from the switching means is stored in the memory means. For example, a portion or portions of an image which contain no picture information (such as the blanking regions) may be ignored and either not digitised by the digitising means and/or not stored by the memory means. Additionally or alternatively, the full image and/or a decimated full image may be selected.

Preferably the system control means determines the dimensions of each image to be stored in the memory means and/or controls the output from the memory means such that each buffered image read from the memory means is of predetermined dimensions.

Preferably, the system control means is operable to generate synchronisation signals to control the operation of the digitising means and/or memory means and/or video Codec means and such synchronisation signals may match the predetermined time base and/or dimensions of the images stored in the memory means.

In a further aspect, the present invention provides a method of operating a video capture system, the method including the steps of:
1. receiving analogue video signals from a plurality of sources;
2. selecting a signal from one of the sources;
3. storing the selected signal in memory means;
4. repeating steps 2 and 3 as required; and
5. at the same time as step 2 and/or step 3, extracting signals from the memory means at a predetermined rate and preferably transferring the signals to video CODEC means.

Other preferred steps of the method will be apparent from the description of the operation of the apparatus given above and may be used with any or all of the aspects described herein. Any feature from any of the various aspects may be combined with any feature(s) from another aspect(s).

Embodiments of the present invention will now be described by way of example with reference to the accompanying drawings in which:

FIG. 1 is a schematic diagram of the architecture of a prior art system;

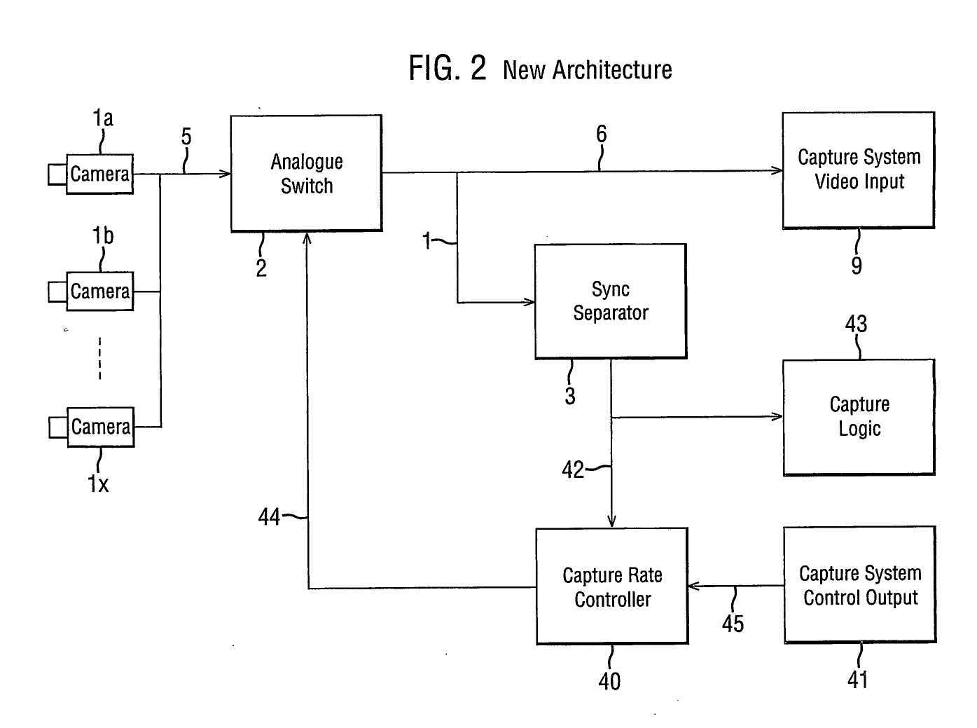

FIG. 2 is a schematic diagram of an embodiment of a video capture system according to the present invention; and

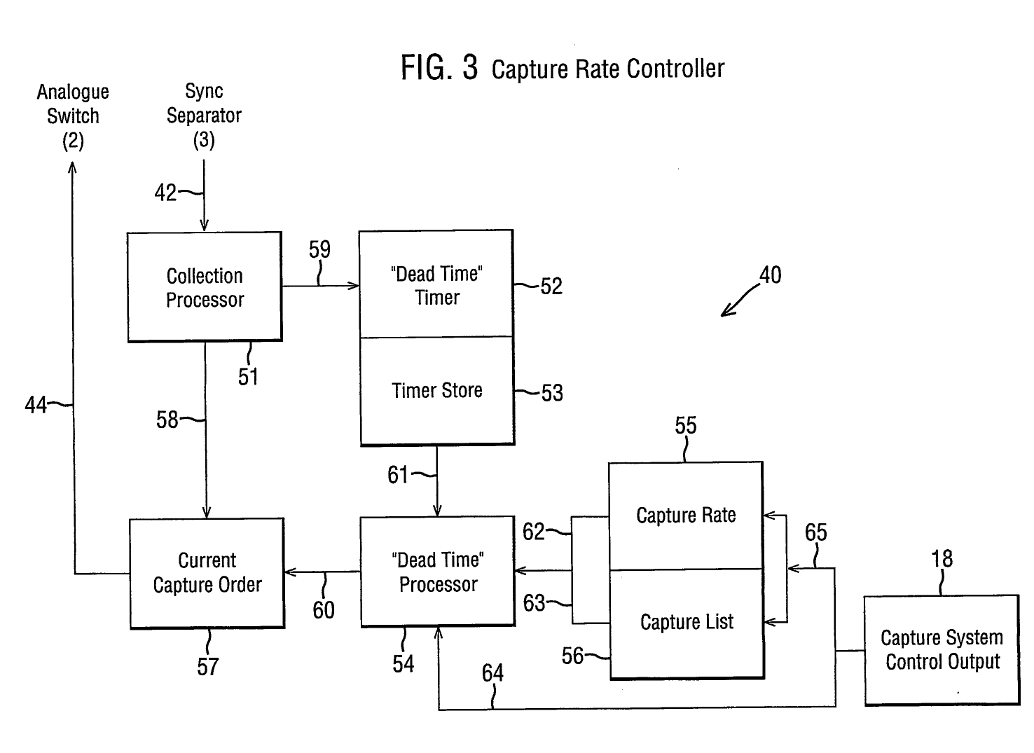

FIG. 3 is a detailed schematic diagram of the capture controller of FIG. 2.

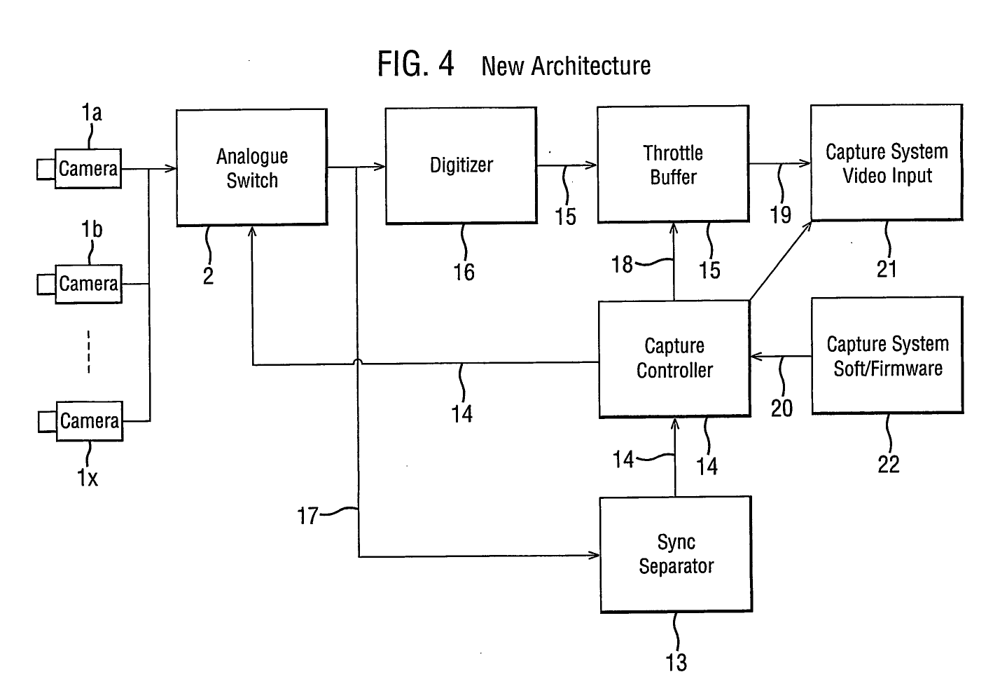

FIG. 4 is a schematic diagram of an embodiment of a buffered video capture system according to the present invention; and

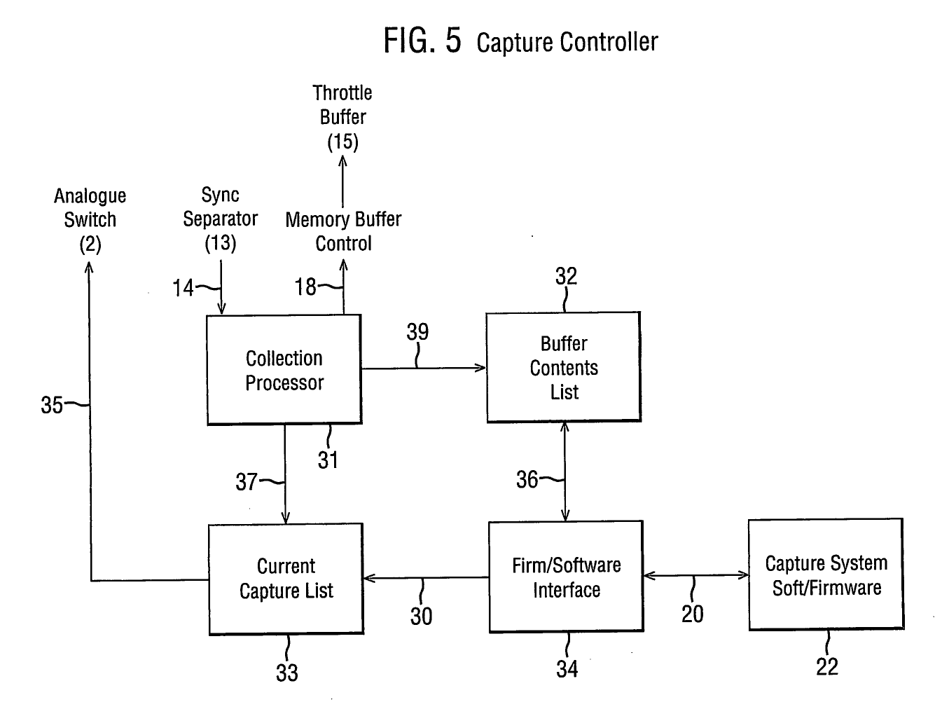

FIG. 5 is a detailed schematic diagram of the capture controller of FIG. 4.

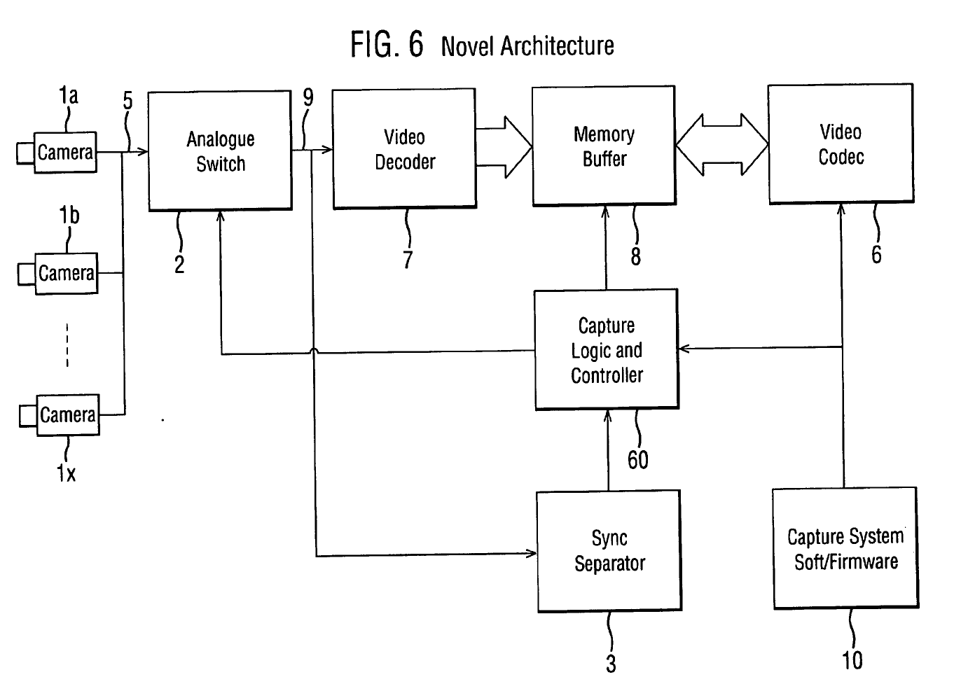

FIG. 6 is a schematic diagram of an embodiment of a video capture system according to the present invention;

FIG. 2 is a schematic diagram of one embodiment of the present invention. A plurality of analogue video cameras 1a, 1b . . . 1X are coupled to an analogue switch 2 so that the respective analogue signals can be fed to the switch. As with the prior art system of FIG. 1, a sync separator 3 monitors the output of the analogue switch 2 to determine properties of the analogue video signal output from analogue switch 2 to the remainder of the capture system 9.

The output of the sync separator 3 is passed both to the capture logic 43 (in a similar manner to the prior art of FIG. 1) and also to a capture rate controller 40 (referred to generally as switching control means in this specification). Preferably utilising information received from the capture system control 41, the capture rate controller 40 determines the operation of the analogue switch 2 for example so as to select the order in which the analogue video signals from each of the cameras 1a, 1b . . . 1X, is captured, as previously described above.

FIG. 3 is a schematic diagram of the capture rate controller 40 in more detail. The current capture list (which determines the order in which each analogue video signal is to be captured) is stored in item 56 and the desired average capture rate (or other desired measure of capture rate, as appropriate) is stored in box 55. The current capture list may include some or all of the available analogue video signal inputs and may include more than one instance of any given input. This information is transferred to the “dead time” processor 54, which also receives information from a timer store 53. The timer store 53 contains the time gap between successive images to be captured, as measured by the dead time timer 52 using information obtained from the sync separator 3 by collection processor 51.

As required, the current accumulated dead time of the input capture system is calculated and compared to the required dead time needed to achieve the current desired capture rate 56. If the figure is outside whatever parameters have been set, the dead time processor 54 uses dead time figures from the timer store 53 to reorder the capture order 57 to maintain the capture rate as close as possible to that desired.

One embodiment of how it could work is a follows:

This example is for PAL mode systems, but can be applied in the same way to other formats, such as NTSC.

Collating the Dead Time Information

The collection processor (51) feeds the sync signals to the dead time timer (52).

Starting from input 1 the dead time timer uses a counter to capture the dead time between the end of one collection and the next DT_{n->n+1}. These values are stored in the timer store (53).

The dead time timer also uses the information to build a “distance map,” analogous to a road mileage chart, which maps the dead time that would occur between any two cameras.

This is carried out as follows:
DT_{1->2}=X
Input 2 collection=20 ms (Field length)
DT_{2->3}=Y
Input 3 collection=20 ms
. . .

Therefore DT_{1->3}=X+Y Modulo 20.

Example
DT_{1->2}=17 ms
DT_{2->3}=10 ms

If we had collected camera 3 after camera 1 the dead time DT_{1->3} would be given by:
17+10 Modulo 20=7 ms

An example of a distance table for a 16 input system for any particular capture cycle stored in the timer store would be

| | From | | | | | | | | | | | | | | | |
|---|---|---|---|---|---|---|---|---|---|---|---|---|---|---|---|---|
| To | 1 | 2 | 3 | 4 | 5 | 6 | 7 | 8 | 9 | 10 | 11 | 12 | 13 | 14 | 15 | 16 |
| 1 | | 8.8 | 17.7 | 15.6 | 17.2 | 14.5 | 16.1 | 4.5 | 10.7 | 1.3 | 14.4 | 17.7 | 4.5 | 13 | 13.6 | 0 |
| 2 | 19.3 | | 12.6 | 18.4 | 13.5 | 16.5 | 19.3 | 19.1 | 12.7 | 9.8 | 11.5 | 16 | 7 | 3.5 | 10.6 | 17.7 |
| 3 | 1 | 15.4 | | 9.9 | 6.9 | 7.9 | 18.8 | 17.8 | 18.2 | 6 | 0.5 | 18.3 | 19.6 | 10.4 | 1.4 | 15.6 |
| 4 | 6.9 | 13.7 | 8.6 | | 3.9 | 10.9 | 14.7 | 1.2 | 6.9 | 0.8 | 10.9 | 2.5 | 9.5 | 7.8 | 8.9 | 16.8 |
| 5 | 8.4 | 8.9 | 0.1 | 6.1 | | 5 | 10.5 | 1.5 | 7.6 | 0.6 | 8 | 9.9 | 10.2 | 0.9 | 11.6 | 19.3 |
| 6 | 1 | 14.8 | 15.6 | 19 | 2.3 | | 17.1 | 13.6 | 1.5 | 3 | 6.1 | 6.3 | 18.7 | 17.1 | 0.4 | 12.2 |
| 7 | 8 | 0.5 | 14.4 | 13 | 13.6 | 4 | | 19 | 16.8 | 1.9 | 0.8 | 9.5 | 1.9 | 3.9 | 15.2 | 6 |
| 8 | 15.5 | 17.2 | 10.9 | 0.4 | 15.4 | 13.9 | 11.1 | | 16.8 | 1.4 | 8.8 | 11 | 11.1 | 11.6 | 8.4 | 6.9 |
| 9 | 17.4 | 8.3 | 13.7 | 8.3 | 11.3 | 18.3 | 15.4 | 0 | | 18 | 16.3 | 19.2 | 8.1 | 8.9 | 7.8 | 1.4 |
| 10 | 9.8 | 0.9 | 15.2 | 10.4 | 2.1 | 15.7 | 2.7 | 15.9 | 5.5 | | 14.6 | 13.3 | 12.5 | 10.6 | 15.8 | 13 |
| 11 | 12.5 | 6.9 | 5.7 | 8.6 | 12.7 | 18.4 | 1.8 | 18.8 | 0.1 | 7.2 | | 2.2 | 15.8 | 16.4 | 3.4 | 0.3 |
| 12 | 6.3 | 0.9 | 3.3 | 12.3 | 13.7 | 7 | 16.6 | 8.1 | 12.9 | 1.2 | 3.5 | | 10.6 | 15.8 | 14.4 | 8.9 |
| 13 | 10.5 | 12.1 | 10.7 | 19.5 | 5.3 | 14.7 | 18.2 | 0.8 | 17.5 | 10 | 7.1 | 17 | | 14.8 | 13.5 | 8.3 |
| 14 | 8.6 | 5.7 | 12.5 | 14.9 | 17.7 | 6.3 | 0.4 | 2 | 3 | 12.3 | 15.3 | 5.5 | 15.1 | | 5 | 11.6 |
| 15 | 11.4 | 0.1 | 19.6 | 6.5 | 17.6 | 7.9 | 3.2 | 11.2 | 6.7 | 7.8 | 6.7 | 15.6 | 19 | 3.9 | | 16.7 |
| 16 | 4.1 | 7.3 | 12.8 | 8.4 | 16.1 | 0 | 6.7 | 1.4 | 18 | 15.8 | 17.6 | 5.1 | 19.8 | 9.3 | 16.9 | |

Where the numbers represent the dead time that would occur if the input across the top (From) was switched to the camera down the side (To), in ms.

Calculating the Requirements for a Particular Required Field Rate

The collection time for any image is 20 ms from vertical sync to vertical sync. Embodiments that switch at the end of the collection (Some ms prior to the second vsync) would normally be used, but using vsync to vsync eases the calculation.

If we take a specific field rate of n fps, then the required total dead time DTT can be found from:
DT_{T}=1000(ms)−(n×20(ms))

The required dead time per individual field collection DT_{I} can be found from:
DT_{I}=DT_{T}/n

Example:
Required rate=40 fps
   DT_{T}=1000(ms)−(40×20(ms))=200 ms
   And therefore
   DT_{I}=200/40=5 ms
   Calculating the Best Fit Follection Sequence

When a recalculation of the order is triggered the Dead Time Processor (54) uses the distance table and individual dead time figures as follows:

Starting at an arbitrary input, say 1, the processor looks for another input where the dead time to the next collection would be, within bounds, DT_{I} from camera 1. Moving to that camera, the processor then repeats the selection process, increasing or decreasing the required DT_{I} for each switch to keep the overall total inline with DT_{T}.

On completion of the cycle an error can be calculated, given by DT_{T}−DT_{A}, where DT_{A}=Actual dead time from calculation, which can then be used in subsequent calculations to ensure that the DT_{A} is maintained as close to the required DT_{T} as possible, over time.

Each new capture order is sent to the current capture order store (57) for use by the collection processor (51).

The cycle can then be repeated as necessary.

As the buffer is filled with images, preferably the capture system software/firmware (22) should keep track of the locations of the images in the buffer. In addition, preferably the contents list (32) holds the address and/or size of each of the images in the buffer, in order to support retrieval of the images from the buffer.

Functionally, in preferred embodiments, the capture controller may be able to perform any or all of the following functions:
a) resize images e.g. as they are output
b) read images from the buffer in a different order to that in which they were written
c) read images at a predetermined rate
d) insert the output data from the buffer into a predetermined time base, which time base may be generated by the capture controller.

FIG. 4 is a schematic diagram of an example of a video capture system according to an embodiment of the present invention. As in the prior art system of FIG. 1, a plurality of analogue video cameras 1a, 1b . . . 1x, are connected via input means to an analogue switch 2.

A capture controller 14 (whose operation is controlled by capture system software or firmware 22) controls the operation of the analogue switch 2 so as to select a video signal from one of the video cameras at a time. The selected video signal is digitised by digitiser 16 and then stored in a throttle buffer 15. The capture controller 14 may monitor one or both of (a) the output of the analogue switch 2 (for example so as to be able to detect the start and/or finish of the “active” region of the selected video signal, e.g. via a sync separator 13), and/or (b) the operation (e.g. the input operation) of the throttle buffer 15. In this way, the capture controller 14 can optimise the input to the throttle buffer.

System control means (not shown) can then control the reading of data from the throttle buffer at a predetermined rate to a video processor via capture system video input 21.

The capture controller 14 is shown in more detail in FIG. 5. The capture controller includes a firmware/software interface 34 for interfacing with the capture system software or firmware 22. The interface 34 permits communication with a capture list 33 which in turn controls operation of the analogue switch 2.

The capture list 33 also receives data via a collection processor 31 from the sync separator 13. The collection processor 31 may be equivalent to the capture rate controller but including throttle buffer support, and controls a memory buffer control in order to control the input of data to the throttle buffer 15. In addition, the collection processor 31 updates a buffer contents list 32 which also receives data via the interface 34.

FIG. 6 is a schematic diagram of one embodiment of the present invention. A plurality of analogue video cameras 1a, 1b . . . 1X are coupled to an analogue switch 2 so that the respective analogue signals can be fed to the switch. As with the prior art system of FIG. 1, a sync separator 3 monitors the output of the analogue switch 2 to determine properties of the analogue video signal output from analogue switch 2 to the remainder of the capture system 9.

The output of the sync separator 3 is passed to the capture logic and controller 60 (referred to generally as switching control means in this specification) in a similar manner to the prior art of FIG. 1. The capture controller 60 determines the operation of the analogue switch 2, for example so as to select the order in which the analogue video signals from each of the cameras 1a, 1b . . . 1X, is captured, and to select a video signal from one of the video cameras at a time.

The selected video signal is digitised by video decoder 7 and then stored in a memory buffer 8. The capture controller 60 may monitor one or both of (a) the output of the analogue switch 2 (for example so as to be able to detect the start and/or finish of the “active” region of the selected video signal, e.g. via a sync separator 3), and/or (b) the operation (e.g. the input operation) of the memory buffer 8. In this way, the capture controller 60 can optimise the input to the buffer 8.

Data is transferred to/from the buffer 8 at a predetermined rate to/from a video Codec 6.

Preferably the capture logic and controller 60 controls the size of the digitised image in the memory buffer and/or the portion of the original video image received at input 9 which is digitised by video decoder 7 and/or stored in the buffer 8. For example, as mentioned previously, a typical CCR-601 video camera image has a digitised resolution of 864 pixels by 312.5 lines. Of this, a large portion is what is known as “blanking” and contains no actual picture information. The active area of a full size image, from which the area to be compressed in the present invention is actually, for example, 720 pixels by 288 lines. By storing only this smaller image in the memory buffer, for subsequent compression by the video Codec 6, the time taken for compression by the Codec 6 is reduced (in this case by e.g. 23%) i.e. the Codec can be used more efficiently to compress more images in a given amount of time. Taking this further, a decimated image, such as 360 pixels×144 lines would reduce the time taken for a compression, using this method by 80% over that taken by the old architecture.

Preferably the capture logic and controller 60 also generates synchronisation signals or codes which match the predetermined time base and/or dimensions of the stored images to be read from the buffer 8 to the Codec 6. Preferably the synchronisation signals or codes minimise the amount of non-active data (e.g. non-image data) present in the video stream to the Codec 6.

Similarly, images may also be decompressed using the video Codec 6 and read back into the memory buffer 8. In addition, preferably, images can be read to and from the memory buffer in any order determined by the capture logic and controller 60 and/or the capture system soft/firm ware 10.

Functionally, in preferred embodiments, the capture controller 60 may be able to perform any or all of the following functions:
a) resize images e.g. as they are output
b) read images from the buffer in a different order to that in which they were written
c) read images at a predetermined rate
d) insert the output data from the buffer into a predetermined time base, which time base may be generated by the capture controller.

The invention may include any variations, modifications and alternative applications of the above embodiments, as would be readily apparent to the skilled person without departing from the scope of the present invention in any of its aspects.

1. A video capture system including: input means for receiving a plurality of analogue video signals, each analogue video signal including a plurality of active periods, there being dead time periods between successive inputs of different video signals; switching means for selecting any one of the analogue video signals for capture; switching control means for receiving information relating to the active periods of each analogue video signal and/or the dead time periods between some or all of the video signals, and determining the operation of the switching means on the basis of this information to select the order in which the analogue video signals are captured.

2. A video capture system according to claim 1 wherein the switching control means is operable to select the order in which the analogue video signals are processed so as to substantially maintain a desired average capture rate.

3. A video capture system according to claim 1 wherein the switching control means is operable to select the order in which the analogue video signals are processed in order to achieve an increased capture rate or to maintain the capture rate above a predetermined minimum rate.

4. A video capture system according to claim 1 wherein the switching control means controls the operation of the switching means.

5. A video capture system according to claim 1 wherein the switching control means monitors the signals output from the switching means and detects the portion of each frame of each analogue video signal which contains image data.

6. A video capture system according to claim 1 wherein the switching control means is operable to control the switching means to select between different ones of the plurality of analogue video signals in accordance with the order determined by the information received.

7. A video capture system according to claim 1 wherein the switching control means is operable to determine any order for capturing the analogue video signals and is operable to amend that order at predetermined time intervals.

8. A video capture system according to claim 1 wherein the capture order is selected from a predetermined list of available capture orders and such a selection is done on the basis of which of the available orders most closely provides the desired objective of obtaining a desired average collection rate, a best possible collection rate and/or maintaining a minimum collection rate.

9. A video capture system according to claim 8 wherein the selection is repeated at predetermined time intervals.

10. A video security system including: a video capture system according to claim 1; and a plurality of analogue video cameras whose signals are fed to the input means of the video capture system.

11. A video capture system according claim 1 including: —memory means for storing signals output from the switching means; and system control means for extracting signals from the memory means at a predetermined rate, and preferably transferring the signals to video CODEC means.

12. A video capture system according to claim 11 wherein the memory means is usable to store signals from all of the input means.

13. A video capture system according to claim 11 wherein the switching control means is operatable independently of the system control means so that the switching control means can control the capture of the analogue video signals and, their subsequent storage in the memory means in an asynchronous manner at whatever rate is appropriate.

14. A video capture system according to claim 13 wherein the system control means is operable to extract signals from the memory means at the predetermined rate.

15. A video capture system according to claim 14 wherein the predetermined rate of extracting signals from the memory means is approximately the same as the average input rate of the storing of signals in the memory means, so that the memory means will not overflow or empty.

16. A video capture system according to claim 11 wherein the switching control means and/or the system control means is/are operable so that the memory means may be written to and read from simultaneously.

17. A video capture system according to claim 11 wherein the system control means is operable to control the memory means and/or the digitising means such that only a portion of each signal output from the switching means is stored in the memory means.

18. A video capture system according to claims 11 to 17 wherein the system control means is operable to determine the dimensions of each image to be stored in the memory means and/or control the output from the memory means such that each buffered image read from the memory means is of predetermined dimensions.

19. A method of operating a video capture system, the method including the steps of: 1. receiving analogue video signals from a plurality of sources, each analogue video signal including a plurality of active periods and respective dead time periods between the active periods; 2. selecting a signal from one of the sources for capture; 3. receiving information relating to the active period and/or dead time periods of the analogue video signals; 4. repeating step 2 on the basis of the information received in step 3.
